(19) United States
(12) Patent Application Publication
(10) Pub. No.: US 2025/0330072 A1
(43) Pub. Date: Oct. 23, 2025

(54) PERMANENT MAGNET ELECTRIC MACHINE AND METHOD OF FIELD WEAKENING IN A PERMANENT MAGNET ELECTRIC MACHINE

(71) Applicant: DEERE & COMPANY, MOLINE, IL (US)

(72) Inventors: RANDALL L. LONG, COFFEYVILLE, KS (US); STACY K. WORLEY, COFFEYVILLE, KS (US)

(21) Appl. No.: 18/643,421

(22) Filed: Apr. 23, 2024

(51) Int. Cl. H02K 15/00; H02K 1/276; H02K 1/32

(52) U.S. Cl. CPC H02K 15/50; H02K 1/276; H02K 1/32; H02K 2213/09

(57) ABSTRACT

A method of field weakening and a permanent magnet electric machine includes a stator and a rotor having magnets arranged annularly about the axis of rotation. The magnets are disposed in cavities of the rotor. A fluid passageway extends through the rotor and fluidly connects to the cavities such that flow of a fluid through the fluid passageway moves the magnets from a first position to a second position within the cavities.

### BACKGROUND

Electric machines, including motors and generators, convert electrical energy into mechanical energy and/or mechanical energy into electrical energy. Permanent magnet electric machines perform such conversions using permanent magnets to generate magnetic fields. Field weakening involves control of such electric machines and may be used for extending the speed range of the electric machine while maintaining desired torque and power output. Field weakening may involve reduction of the effect of the magnetic field generated by the permanent magnets to allow the electric machine to operate beyond a base speed of the electric machine.

### SUMMARY

In accordance with aspects of the present disclosure, a method of field weakening in a permanent magnet electric machine includes a rotor, an axis of rotation, and a stator includes rotating a rotor having a plurality of magnets arranged annularly about the axis of rotation with each of the plurality of magnets being disposed in a respective at least one of a plurality of cavities of the rotor, circulating a fluid through a fluid passageway extending through the rotor to each of the plurality of cavities, and moving the plurality of magnets with the fluid from a first position to a second position within the plurality of cavities.

Moving the plurality of magnets may include moving the plurality of magnets with the fluid from the first position to the second position within the plurality of cavities when a rotational speed of the rotor is greater than a threshold rotational speed. The method may further include moving the plurality of magnets with the fluid within the plurality of cavities from the second position to the first position when the rotational speed of the rotor is less than the threshold rotational speed. The method may further include moving a second plurality of magnets with the fluid within a second plurality of cavities from a third position to a fourth position when the rotational speed of the rotor is greater than the threshold rotational speed. The method may further include moving the second plurality of magnets with the fluid within the second plurality of cavities from the fourth position to the third position when the rotational speed of the rotor is less than the threshold rotational speed. The method may further include controlling a temperature of the plurality of magnets with the fluid upon circulating the fluid through the fluid passageway extending through the rotor to the plurality of cavities. Moving the plurality of magnets may include pivoting each of the plurality of magnets radially about a magnet pivot axis that is parallel with the axis of rotation. The magnet pivot axis may be centered at a radially lower end of each of the plurality of magnets relative to the axis of rotation. Pivoting each of the plurality of magnets may include pivoting each of the plurality of magnets radially inwardly from the first position to the second position about the magnet pivot axis that is parallel with the axis of rotation. Pivoting each of the plurality of magnets may include pivoting each of the plurality of magnets radially outwardly from the first position to the second position about the magnet pivot axis that is parallel with the axis of rotation.

In accordance with aspects of the present disclosure, a permanent magnet electric machine includes a stator comprising a plurality of stator windings, a rotor configured to rotate about an axis of rotation and comprising a plurality of magnets arranged annularly about the axis of rotation with each of the plurality of magnets being disposed in a respective at least one of a plurality of cavities of the rotor, and a fluid passageway extending through the rotor and fluidly connected to the plurality of cavities such that flow of a fluid through the fluid passageway moves the plurality of magnets from a first position to a second position within the plurality of cavities.

Each of the plurality of magnets in the plurality of cavities may be positioned at a first position when a rotational speed of the rotor is less than a threshold rotational speed. Each of the plurality of magnets in the plurality of cavities may be positioned at a second position when the rotational speed of the rotor is greater than the threshold rotational speed. The rotor may further comprise a second plurality of magnets arranged circumferentially in a second plurality of cavities and positioned at a third position when the rotational speed of the rotor is less than the threshold rotational speed and positioned at a fourth position when the rotational speed of the rotor is greater than the threshold rotational speed. The fluid may have a fluid temperature that is less than a magnet temperature of the plurality of magnets. Each of the plurality of cavities may include a radially outer end having a radially outer width that is greater than a radially inner width of a radially inner end such that each of the plurality of magnets pivots radially relative to the axis of rotation about a magnet pivot axis that is parallel with the axis of rotation. The magnet pivot axis may be centered at a radially lower end of each of the plurality of magnets relative to the axis of rotation. The first position may be defined by each of the plurality of magnets extending at a first angle relative to the axis of rotation, and the second position may be defined by each of the plurality of magnets extending at a second angle relative to the axis of rotation. The first angle may be greater than the second angle. The first angle may be less than the second angle.

Other features and aspects will become apparent by consideration of the detailed description, claims, and accompanying drawings.

### BRIEF DESCRIPTION OF THE DRAWINGS

The detailed description of the drawings refers to the accompanying figures.

FIG. 1 illustrates an electric machine in accordance with an embodiment of the present disclosure;

FIG. 2 is an axial cross-sectional view of an electric machine in accordance with an embodiment of the present disclosure;

FIG. 3 is an enlarged axial cross-sectional view of an electric machine in accordance with an embodiment of the present disclosure;

FIG. 4 is an enlarged axial cross-sectional view of an electric machine in accordance with an embodiment of the present disclosure; and

FIG. 5 is a radial cross-sectional view of an electric machine in accordance with an embodiment of the present disclosure.

Like reference numerals are used to indicate like elements throughout the several figures.

### DETAILED DESCRIPTION

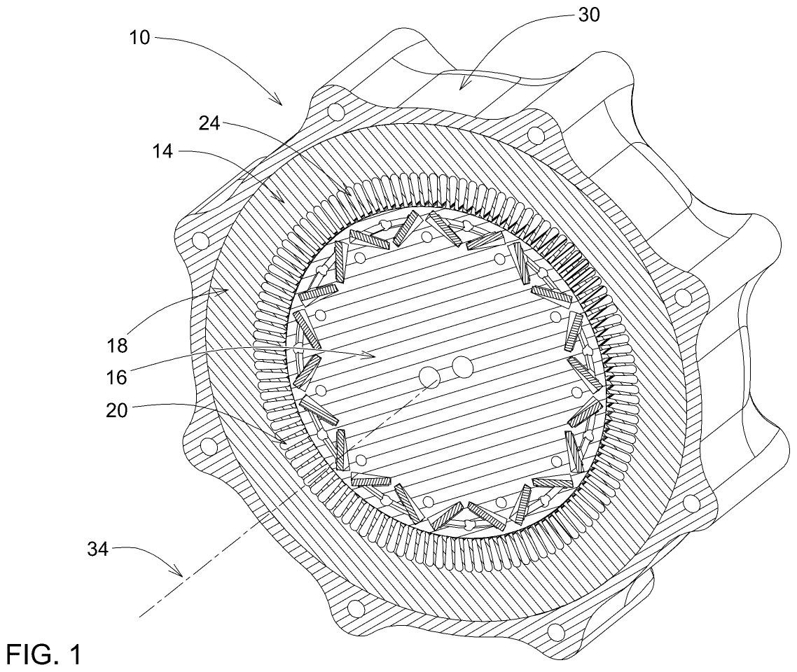

Referring to FIGS. 1-5, an electric machine 10 in accordance with one or more embodiments of the present disclosure is illustrated. The electric machine 10 shown in FIG. 1 is a permanent magnet electric machine, also referred to as a permanent magnet motor or generator, which is a type of electric machine that uses permanent magnets to create magnetic fields. The electric machine 10 of one or more additional embodiments includes similar motor, generator, or electric machine types. The electric machine 10 illustrated in FIG. 1 includes a rotor 16 and a stator 14 surrounding or encircling the rotor 16. The stator 14 includes stator windings 20.

In the electric machine 10, the magnetic field(s) of the rotor 16 synchronizes with the magnetic field(s) of the stator 14. This may result in constant or synchronous speed operation. Permanent magnet synchronous machines such as embodiments of the electric machine 10 may be used in applications requiring high efficiency, precise speed control, and high torque at low speeds.

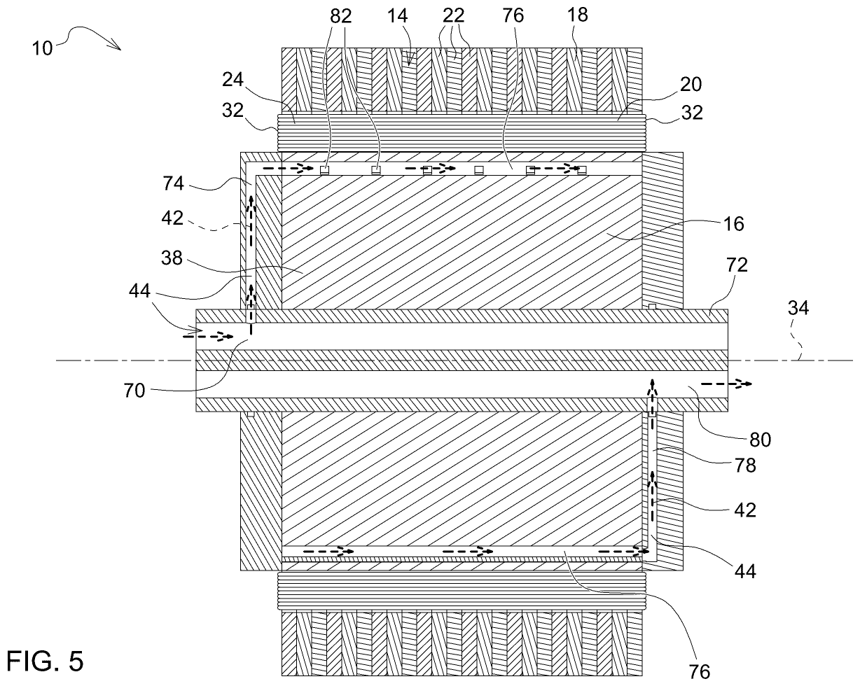

The stator 14 of the electric machine 10 is stationary and provides magnetic field(s) to induce electromotive force and generate torque. The stator 14 includes a stator core 18 that may be made of laminations 22, such as electrical steel in a non-limiting example, providing a low-reluctance magnetic path for the magnetic flux generated by the stator windings 20, as illustrated in FIG. 5. The laminations 22 may be stacked and bonded together to form the stator core 18. The stator core 18 of the illustrated embodiment of FIGS. 1-5 has a cylindrical shape with slots 24 on a core inner surface to accommodate the stator windings 20.

The stator windings 20 illustrated in FIG. 5, also referred to as stator coils or armature windings, may be made of insulated copper or aluminum conductors. The stator windings 20 are wound around the stator core 18 and positioned in the slots 24 that are shown in FIGS. 1, 2, and 5. The stator windings 20 generate a rotating magnetic field when a current, such as an alternating current, flows through the stator windings 20. This magnetic field(s) interacts with the magnetic field(s) of the rotor 16 to create torque and drive the rotor 16. Stator windings 20 of one or embodiments of the electric machine 10 of the present disclosure may be arranged in various configurations, such as single-phase, three-phase, or multi-phase, depending on the design and application requirements of the electric machine 10. The stator windings 20 are insulated from the stator core 18 and each other using various insulation materials, such as enameled wire coatings, insulating paper, and/or mica-based sheets. Insulation may prevent or reduce electrical short-circuits between the stator windings 20 and between the stator windings 20 and the stator core 18 and to protect the stator windings 20 from environmental factors such as moisture, dust, and chemicals. End windings 32 are portions of the stator windings 20 that extend beyond the stator core 18 and connect individual coils of the stator windings 20 to form a desired winding configuration. End windings 32 are secured to prevent movement, vibration, or damage during operation of the electric machine 10. The end windings 32 may be insulated to prevent electrical short-circuits and/or enclosed in protective covers or end shields to protect them from environmental factors.

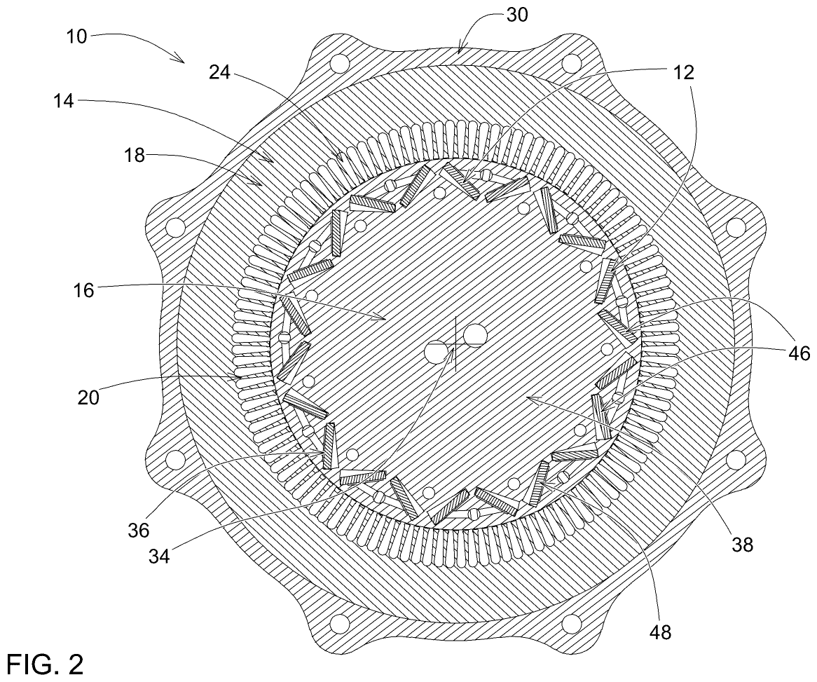

As illustrated in FIGS. 1 and 2, the stator 14 further includes a stator frame 30 that encloses the stator core 18 and stator windings 20. The stator frame 20 may be made from cast iron, steel, and/or aluminum alloys. The stator frame 20 may provide mechanical support and protection for the internal components of the electric machine 10, aid in heat dissipation, and serve as a mounting structure for the electric machine 10. The stator frame 20 of one or more embodiments may include cooling fins, vents, or cooling channels to facilitate heat transfer and maintain the temperature of the stator 14 within acceptable limits.

The rotor 16 rotates about an axis of rotation 34 as illustrated in FIGS. 1 and 2. As shown in FIG. 2, the rotor 16 includes magnets 12, 46 arranged annularly or circumferentially about the axis of rotation 34. Each magnet 12, 46 is disposed in a respective cavity 36, 48 of the rotor 16. In the illustrated embodiment, each magnet 12, 46 is disposed in one of the cavities 36, 48 and, in additional embodiments not illustrated, multiple magnets 12, 46 may be disposed in each cavity 36, 48.

In a permanent magnet machine, such as the permanent magnet synchronous machine illustrated in FIG. 2 or a brushless direct current machine, the rotor 16 includes the magnets 12, 46 embedded within a rotor core 38. The magnets 12, 46 may be composed of materials such as neodymium iron boron (NdFeB) and/or samarium cobalt (SmCo) in non-limiting examples. The rotor core 38 may be composed of iron in a non-limiting example and provide a low-reluctance path for the magnetic flux, ensuring efficient interaction between the magnetic fields of the rotor 16 and stator 14. The rotor 16 may rotate using and may be supported by bearings (not shown), which may also maintain the proper alignment of the rotor 16, minimize vibration during operation, withstand the mechanical stresses and temperatures experienced by the electric machine 10.

The fundamental operation of the electric machine 10 is based on the interaction between the magnetic fields generated by the array of magnets 12, 46 and the current-carrying conductors of the stator windings 20. When the electric machine 10 operates as a motor, the permanent magnets 12, 46 produce a fixed magnetic field, and when an electric current is provided to the conductors of the stator windings 20, a secondary magnetic field is generated. The interaction between these two magnetic fields generates torque that drives the rotor 16. The process is inverted when the electric machine 10 acts as a generator. Mechanical energy, which may be supplied by a prime mover like a turbine or engine or the drivetrain of a vehicle, propels the rotor 16, causing the magnets 12, 46 to rotate within the stator windings 20. The motion of the magnets 12, 46 in the rotor 16 induces an electromotive force (EMF) in the stator windings 20, thereby generating an electric current.

It will be recognized that the magnets 12, 46 of the electric machine 10 may be directly or indirectly cooled by one or more techniques and/or systems in accordance with one or more embodiments of the present disclosure. Cooling the magnets 12, 46 in the rotor 16 of the electric machine 10 maintains magnet performance, prevents demagnetization, and improves the overall efficiency and reliability of the electric machine 10. Heat generated within the electric machine 10, such as from copper losses in the stator windings 20 and iron losses in the stator and rotor cores, may cause the temperature of the magnets 12, 46 to increase. Excessive temperatures may lead to a reduction in magnetic flux density, resulting in decreased motor performance, efficiency, and possible demagnetization of the magnets 12, 46. Further, high-speed operation and high power density can exacerbate the increase in heat generation and temperature, increasing the need for cooling of the magnets 12, 46 for maintaining performance and reliability of the electric machine 10.

The electric machine 10 illustrated in FIGS. 2-5 includes direct cooling of the magnets 12, 46 through circulation of a fluid 42, such as a liquid that is and/or contains dielectric oil, ethylene glycol, propylene glycol, and/or one or more additional fluids in non-limiting examples. The fluid 42 is circulated through a fluid passageway 44 that extends through the rotor 16. The fluid passageway 4 fluidly connects to the cavities 36, 48 to directly cool or otherwise control the temperature of the magnet(s) 12, 46 disposed in the cavities 36, 48. The fluid passageway 44 includes one or more embedded cooling channels within the rotor core 38. The fluid 42 flows directly around the magnet 12, 46 and/or is sprayed or otherwise impinges directly onto one or more surfaces of each magnet 12, 46. In an embodiment, the fluid 42 has a fluid temperature that is less than a magnet temperature of the magnets 12, 46.

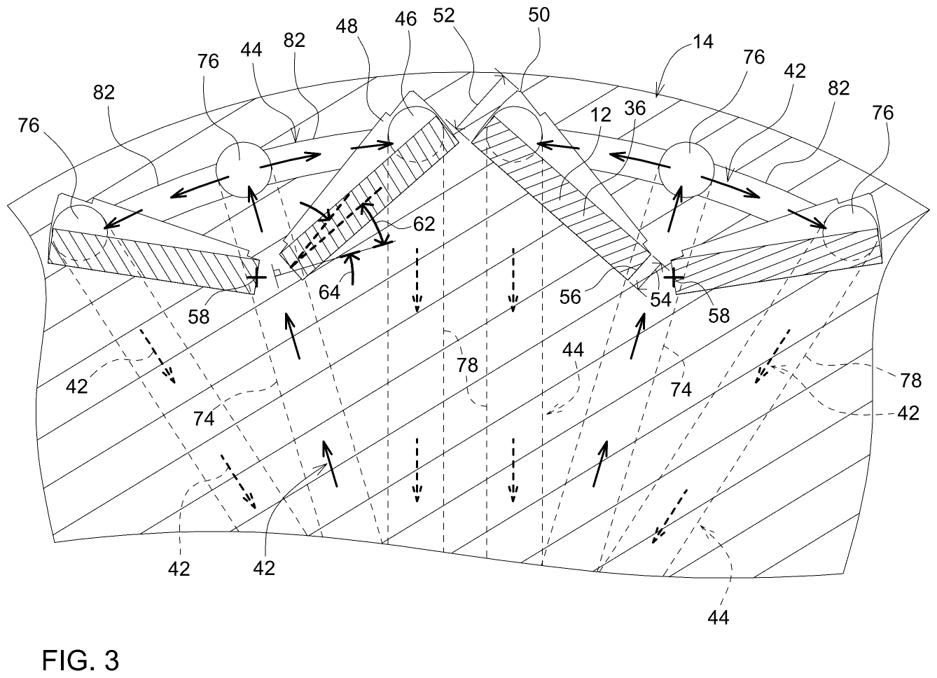

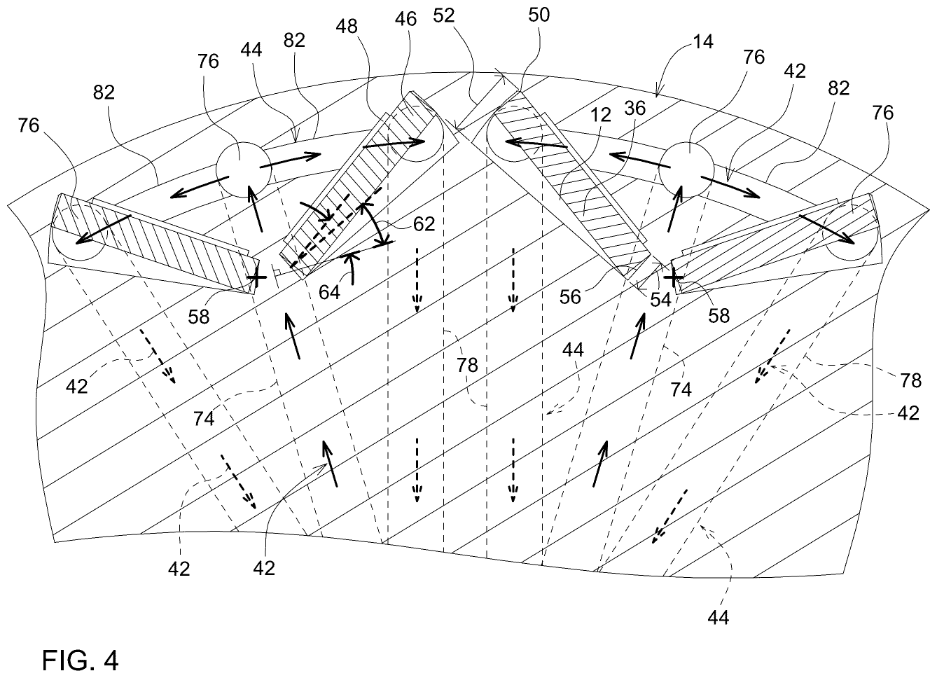

Referring to FIGS. 3-5, the fluid passageway 44 of the illustrated embodiment includes one or more supply passageway(s) 70 extending axially through a shaft 72 coupled to the rotor 16. The fluid passageway 44 of FIGS. 3-5 further includes one or more first passageway(s) 74 extending radially. The first passageway(s) 74 connect the supply passageway 70 to one or more second passageway(s) 76 extending axially. The second passageway(s) 76 extend axially from the first passageway(s) 74 to one or more third passageway(s) 78. As illustrated in FIGS. 3 and 4, second passageway connectors 82 of an embodiment extend circumferentially to circulate the fluid 42 to or around the magnets 12, 46 and connect multiple second passageways 76. The third passageway(s) 78 extend radially from the second passageway(s) 76 to one or more return passageway(s) 80 extending axially through the shaft 72. In the illustrated embodiment, the fluid 42 circulating in the supply passageway(s) 70 is at a greater pressure than the fluid 42 circulating in the return passageway(s) 80 to allow circulation through the fluid passageway 44. In the illustrated embodiment, there is a single supply passageway 70 and a single return passageway but multiple first, second, and third passageways 74, 76, 78 circumferentially spaced about the axis of rotation 34.

Cooling the magnets 12, 46 of the electric machine 10 maintains machine performance and efficiency by preventing excessive temperature rise and demagnetization of the magnets 12, 46, which is especially important in high-power and high-speed applications, where heat generation and temperature rise are more pronounced. Cooling may also improve machine reliability and extend lifespan by preventing thermal degradation of the machine's structural components, such as the insulation materials and bearings.

The electric machine 10 of one or more embodiments of the present disclosure includes one or more power electronics, control systems, and control algorithms, such as vector control and direct torque control in non-limiting examples, to achieve precise speed and torque control. The electric machine 10 may further include one or more sensors and/or transmitters to enable real-time monitoring and diagnosis of the electric machine 10 to improve reliability and reduce maintenance costs. Advanced control and design of the electric machine 10 in accordance with one or more embodiments disclosed herein may eliminate the need for a transmission or gearbox to reduce mechanical losses and maintenance requirements, resulting in higher energy conversion efficiency and lower operational costs.

With reference to FIGS. 2-4, in accordance with an embodiment of the present disclosure, flow of the fluid 42 of the fluid passageway 44 extending through the rotor 16 of the electric machine 10 moves or reorients the magnets 12 from a first position or orientation, as illustrated in FIG. 3, to a second position or orientation, as illustrated in FIG. 4, within the cavities 36. Each of the magnets 12 in the cavities 36 is positioned at a first position or orientation, as illustrated in FIG. 4, when a rotational speed of the rotor 16 is less than a threshold rotational speed. Each of the magnets 12 in the cavities 36 is positioned at a second position or orientation, as illustrated in FIG. 3, when the rotational speed of the rotor 16 is greater than the threshold rotational speed.

The magnets 12 of the rotor 16 of an embodiment may include multiple groups of magnets 12 having, such as in the exemplary embodiment shown in FIGS. 1 and 2, differing orientations and/or an alternating pattern, such as the 1-2-1-2 alternating pattern illustrated in FIGS. 1 and 2. Accordingly, the rotor 16 may further include the second magnets 46 arranged annularly or circumferentially about the axis of rotation 34 circumferentially in second cavities 48. The second magnets 46 are positioned or oriented at a third position or orientation, as illustrated in FIG. 4, when the rotational speed of the rotor 16 is less than the threshold rotational speed. The second magnets 46 are positioned at a fourth position or orientation, as illustrated in FIG. 3, when the rotational speed of the rotor 16 is greater than the threshold rotational speed. As described herein, the third position or orientation of the magnets 46 generally corresponds to the outer position or orientation or the first position or orientation of the magnets 12 and the fourth position or orientation of the magnets 46 generally corresponds to the inner position or orientation or the second position or orientation of the magnets 12 and may be used interchangeably herein.

When the fluid 42 is not moving the magnets 12, 46 or reorienting the magnets 12, 46 to be in the second position or orientation or the fourth position or orientation, centrifugal force from rotation of the rotor 16 moves or retains the magnets 12, 46 to be in the first position or orientation or the third position or orientation. The fluid 42 flows directly around the magnet 12, 46 and/or is sprayed or otherwise impinges directly onto one or more surfaces of each magnet 12, 46 to cool or otherwise control the temperature of the magnets 12, 46 in an embodiment when the magnets 12, 46 are in the first position or orientation or the third position or orientation.

In an embodiment, the flow of the fluid 42 and/or one or more of the pressure, flow rate, flow direction, and/or other characteristics of the fluid 42 is controlled by one or more pump(s), valve(s), and/or flow control system(s) (not shown) based on input of or related to the rotational speed of the rotor 16 and/or other inputs of or data from the electric machine 10. In an embodiment, a flow of the fluid 42 through the rotor 16 is maintained and continues regardless or pressure flow modulations or changes such that the fluid 42 always flows through the rotor 16. Accordingly, the fluid 42 continues to flow through the cavities 36, 48 even when the magnets 12, 46 are in the first position or orientation and the third position or orientation. In additional embodiments, a flow of the fluid 42 may be also or alternatively stopped, started, or reversed based on, for example, desired cooling and/or control of the position or orientation of the magnets 12, 46 such that the fluid 42 is not continuously flowing as described through or into the cavities 36, 48.

Each of the cavities 36, 48 includes a radially outer end 50 having a radially outer width 52 that is greater than a radially inner width 54 of a radially inner end 56 such that each of the magnets 12, 46 pivots radially inwardly or outwardly relative to the axis of rotation 34 about a magnet pivot axis 58 that is parallel with the axis of rotation 34. The magnet pivot axis 58 is centered at a radially lower end 60 of each of the magnets 12, 46 relative to the axis of rotation 34.

The first and third position is defined by each of the magnets 12, 46 extending at a first angle 62 relative to a radial and circumferential direction from the axis of rotation 34. The second and fourth position is defined by each of the magnets 12, 46 extending at a second angle 64 relative to a radial and circumferential direction from the axis of rotation 34. The first angle 62 is greater than the second angle 64 in an embodiment. The first angle 62 is less than the second angle 64 in another embodiment.

In a non-limiting illustrative example, the first angle 62 is 20 degrees and the second angle 64 is 35 degrees. In other non-limiting examples, the first angle 62 or the second angle 64 is less than 20 degrees, greater than 35 degrees, and/or any angle between 0 and 90 degrees.

Field weakening forms part of control of the electric machine 10 in accordance with embodiments of the present disclosure. Field weakening is a phenomenon that acts to cancel out at least a portion of the magnetic field generated by the magnets 12, 46 to enable operation of the electric machine 10 beyond a base speed while maintaining a desired torque and/or power output characteristics. Field weakening may extend the speed range of the electric machine 10 while keeping the output power constant. In the electric machine 10, output power is the product of torque and speed. At low speeds, the electric machine 10 operates in a constant-torque region, where the available torque is determined by the current supplied to the stator windings 20. As the speed increases, a back electromotive force (EMF) generated by the rotor magnetic field also increases, limiting the voltage and current that can create current in the stator windings (terminal voltage available from the power electronics less the back EMF opposing it) in the electric machine 10. To maintain constant output power at higher speeds, field weakening may be employed to reduce the back EMF and allow for higher current.

Field weakening by adjusting the current vector supplied to the stator windings 20 uses control techniques, such as vector control or direct torque control, which modulate the stator current vector to create a demagnetizing current component. The demagnetizing current component opposes the rotor's magnetic field, and therefore the net field strength in the air gap between the rotor 16 and the stator 14, which reduces the back EMF. An electric machine utilizing these techniques may then operate at higher speeds while maintaining the desired torque and power output. However, such field weakening techniques may increase the risk of demagnetization of the magnets 12, 46 due to the generation of heat in the stator 14 and the magnets 12, 46, increase the complexity of the electric machine control system, reduce the efficiency of an electric machine due to several factors related to the control techniques, power electronics, and the machine's inherent characteristics, and generate additional heat to further affect the efficiency and thermal performance of the electric machine.

In accordance with embodiments of the present disclosure, a method of field weakening in the electric machine 10 of one or more embodiments is disclosed. The method includes rotating the rotor 16, circulating the fluid 42 through the fluid passageway 44 extending through the rotor 16 to each of the cavities 36, and moving or reorienting the magnets 12 with the fluid 42 from the first position or orientation, as illustrated in FIG. 4 in an embodiment, to a second position or orientation, as illustrated in FIG. 3 in an embodiment, within the cavities 36.

The method may include circulating the fluid 42 at a first pressure through the fluid passageway 44 to move or orient the magnets 12 to the first position, as illustrated in FIG. 4 in an embodiment, and circulating the fluid 42 at a second pressure through the fluid passageway 44 to move or orient the magnets 12 to the second position, as illustrated in FIG. 3 in an embodiment. The method includes circulating the fluid 42 through the fluid passageway 44 to some, but not all, of the cavities 36 in an embodiment, and circulating the fluid 42 through the passageway 44 to all of the cavities 36 in an embodiment.

The method may further include moving the magnets 12 with the fluid 42 from the first position or orientation to the second position or orientation within the cavities 36 when a rotational speed of the rotor 16 is greater than a threshold rotational speed. The method may further include moving the magnets 12 with the fluid 42 within the cavities 36 from the second position or orientation to the first position or orientation when the rotational speed of the rotor 16 is less than the threshold rotational speed. The method may further include moving the magnets 46 with the fluid 42 from the third position or orientation to the fourth position or orientation within the cavities 48 when a rotational speed of the rotor 16 is greater than a threshold rotational speed. The method may further include moving the magnets 46 with the fluid 42 within the cavities 48 from the fourth position or orientation to the third position or orientation when the rotational speed of the rotor 16 is less than the threshold rotational speed. In one non-limiting example, the threshold rotational speed is between 2000 and 3000 revolutions per minute (RPM) of the rotor 16. In other non-limiting examples, the threshold rotational speed is less than 2000 RPM or greater than 3000 RPM.

The method of an embodiment includes reducing, increasing, or otherwise controlling a temperature of the magnets 12, 46 with the fluid 42 upon circulating the fluid 42 through the fluid passageway 44 extending through the rotor 16 to the cavities 36, 48.

Moving the magnets 12, 46 may include pivoting each of the magnets 12, 46 radially, inwardly, or outwardly about the magnet pivot axis 58 that is parallel with the axis of rotation 34. The magnet pivot axis 58 of an embodiment is centered at a radially lower end of each of the magnets 12, 46 relative to the axis of rotation 34. Pivoting each of the magnets 12, 46 may include pivoting each of the magnets 12, 46 radially inwardly from the first or third position to the second or fourth position about the magnet pivot axis 58 that is parallel with the axis of rotation 34. Pivoting each of the magnets 12, 46 may include pivoting each of the magnets 12, 46 radially outwardly from the first or third position to the second or fourth position about the magnet pivot axis 58 that is parallel with the axis of rotation 34.

Without in any way limiting the scope, interpretation, or application of the claims appearing below, a technical effect of one or more of the example embodiments disclosed herein is to improve the functionality, efficiency, durability, and performance of the electric machine 10 and the associated methods. In particular, the field weakening functions of the electric machine 10 and methods of field weakening described according to embodiments of the present disclosure allow the electric machine 10 to operate at additional speed ranges and/or with greater efficiency while utilizing the fluid 42 to further improve efficiency by cooling the magnets 12, 46 in the rotor 16 as well as other portions of the rotor 16. Field weakening of various embodiments described herein reduce or eliminate risk of demagnetization of the magnets 12, 46, decrease the complexity of the electric machine 10 and its control system, increase efficiency related to the control techniques and power electronics, and reduce heat generation to further improve efficiency and thermal performance of the electric machine 10.

Any one or more features, structures, and/or functions of any embodiment(s) of the electric machine 10 described or shown herein may be added to or combined with one or more other embodiment(s) of the electric machine 10 described or shown herein, or omitted from such embodiment(s), to form one or more additional embodiment(s) of the electric machine 10 or related methods in accordance with the present disclosure. Additionally, any one or more steps, processes, and/or methods of any embodiment(s) of the electric machine 10 described or shown herein may be added to or combined with one or more other embodiment(s) of the electric machine 10 described or shown herein, or omitted from such embodiment(s), to form one or more additional embodiment(s) of the electric machine 10 or related methods in accordance with the present disclosure.

As used herein, “e.g.” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A method of field weakening in a permanent magnet electric machine having a rotor, an axis of rotation, and a stator, the method comprising:
rotating a rotor comprising a plurality of magnets arranged annularly about the axis of rotation with each of the plurality of magnets being disposed in a respective at least one of a plurality of cavities of the rotor;
circulating a fluid through a fluid passageway extending through the rotor to each of the plurality of cavities; and
moving the plurality of magnets with the fluid from a first position to a second position within the plurality of cavities.

2. The method of claim 1, wherein moving the plurality of magnets comprises moving the plurality of magnets with the fluid from the first position to the second position within the plurality of cavities when a rotational speed of the rotor is greater than a threshold rotational speed.

3. The method of claim 2, further comprising moving the plurality of magnets with the fluid within the plurality of cavities from the second position to the first position when the rotational speed of the rotor is less than the threshold rotational speed.

4. The method of claim 3, further comprising moving a second plurality of magnets with the fluid within a second plurality of cavities from a third position to a fourth position when the rotational speed of the rotor is greater than the threshold rotational speed.

5. The method of claim 4, further comprising moving the second plurality of magnets with the fluid within the second plurality of cavities from the fourth position to the third position when the rotational speed of the rotor is less than the threshold rotational speed.

6. The method of claim 1, further comprising controlling a temperature of the plurality of magnets with the fluid upon circulating the fluid through the fluid passageway extending through the rotor to the plurality of cavities.

7. The method of claim 1, wherein moving the plurality of magnets comprises pivoting each of the plurality of magnets radially about a magnet pivot axis that is parallel with the axis of rotation.

8. The method of claim 7, wherein the magnet pivot axis is centered at a radially lower end of each of the plurality of magnets relative to the axis of rotation.

9. The method of claim 7, wherein pivoting each of the plurality of magnets comprises pivoting each of the plurality of magnets radially inwardly from the first position to the second position about the magnet pivot axis that is parallel with the axis of rotation.

10. The method of claim 7, wherein pivoting each of the plurality of magnets comprises pivoting each of the plurality of magnets radially outwardly from the first position to the second position about the magnet pivot axis that is parallel with the axis of rotation.

11. A permanent magnet electric machine comprising:
a stator comprising a plurality of stator windings;
a rotor configured to rotate about an axis of rotation and comprising a plurality of magnets arranged annularly about the axis of rotation with each of the plurality of magnets being disposed in a respective at least one of a plurality of cavities of the rotor; and
a fluid passageway extending through the rotor and fluidly connected to the plurality of cavities such that flow of a fluid through the fluid passageway moves the plurality of magnets from a first position to a second position within the plurality of cavities.

12. The permanent magnet electric machine of claim 11, wherein each of the plurality of magnets in the plurality of cavities is positioned at a first position when a rotational speed of the rotor is less than a threshold rotational speed.

13. The permanent magnet electric machine of claim 12, wherein each of the plurality of magnets in the plurality of cavities is positioned at a second position when the rotational speed of the rotor is greater than the threshold rotational speed.

14. The permanent magnet electric machine of claim 13, wherein the rotor further comprises a second plurality of magnets arranged circumferentially in a second plurality of cavities and positioned at a third position when the rotational speed of the rotor is less than the threshold rotational speed and positioned at a fourth position when the rotational speed of the rotor is greater than the threshold rotational speed.

15. The permanent magnet electric machine of claim 11, wherein the fluid has a fluid temperature that is less than a magnet temperature of the plurality of magnets.

16. The permanent magnet electric machine of claim 11, wherein each of the plurality of cavities includes a radially outer end having a radially outer width that is greater than a radially inner width of a radially inner end such that each of the plurality of magnets pivots radially relative to the axis of rotation about a magnet pivot axis that is parallel with the axis of rotation.

17. The permanent magnet electric machine of claim 16, wherein the magnet pivot axis is centered at a radially lower end of each of the plurality of magnets relative to the axis of rotation.

18. The permanent magnet electric machine of claim 11, wherein the first position is defined by each of the plurality of magnets extending at a first angle relative to the axis of rotation, and the second position is defined by each of the plurality of magnets extending at a second angle relative to the axis of rotation.

19. The permanent magnet electric machine of claim 18, wherein the first angle is greater than the second angle.

20. The permanent magnet electric machine of claim 18, wherein the first angle is less than the second angle.
